(19) United States
(12) Patent Application Publication
(10) Pub. No.: US 2014/0074317 A1
(43) Pub. Date: Mar. 13, 2014

(54) Method and Apparatus for Wireless Vehicle Accessory Control

(71) Applicant: Daniel Akira Tesler, Salem, MA (US)

(72) Inventor: Daniel Akira Tesler, Salem, MA (US)

(21) Appl. No.: 13/612,835

(22) Filed: Sep. 13, 2012

(51) Int. Cl. G06F 17/00

(52) U.S. Cl. 701/2

(57) ABSTRACT

The present invention relates to a method and apparatus for installing and operating vehicle accessories using a controller with one or more input switches that are powered by the twelve volt power outlet (“power outlet”) commonly installed in the interior of vehicles. By integrating an input switch and controller in a single unit (“controller unit”), powered by a power outlet located in the interior of a vehicle, vehicles accessories can be operated wirelessly. Using a controller unit powered by a power outlet simplifies the installation of vehicle accessories by the end user, eliminates the need for independent batteries in the controller unit, and provides a safer and more ergonomic means for the driver to control the function of a vehicle accessory than currently existing in the art.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a method and apparatus for installing and operating vehicle accessories using a controller with one or more input switches that is powered by the twelve volt power outlet (referred to as a “power outlet” herein) commonly installed in the interior of vehicles. By integrating an input switch and controller in a single unit (referred to as a “controller unit” herein), powered by a power outlet located in the interior of a vehicle, vehicle accessories can be installed more easily, operated wirelessly and operated more safely by the driver. Using a controller unit powered by a power outlet simplifies the installation of vehicle accessories by the end user, eliminates the need for independent batteries in the controller unit, and provides a safer and more ergonomic means for the driver to control the function of a vehicle accessory than currently existing in the art.

Wireless control of vehicle accessories is particularly useful in the installation of aftermarket vehicle accessories, such as fog lights, by the end user. Using a wireless control allows the end user to simply wire the accessory to a twelve volt power source, for example, using a fused connection to the vehicle's battery, and then plug the controller unit into the power outlet to immediately control the new accessory. This invention creates an ergonomic mounting system for the controller unit in the interior of the vehicle and also eliminates the need for batteries in the controller unit. By controlling the vehicle accessory wirelessly, the end user will save a significant amount of time in installing a new accessory by not having to route wires through the firewall and dashboard of the vehicle for a hardwired switch. An added benefit of using the power outlet as the power source is that in newer vehicles, they are commonly wired to turn on and off with the ignition switch. This would cause any accessories wired to the switch to also turn on and off with the ignition switch, preventing accessories from being left energized inadvertently.

U.S. Pat. No. 6,177,867 details a system for wireless communication between components of a vehicle. The prior art limits itself to the use of Digital Enhanced Cordless Telecommunications protocol and is also directed to the reduction of “bundles of wires” run through a vehicle by using a pair of wires as a “power bus” throughout the vehicle.

This invention is not directed at the reduction of “bundles of wires” in a vehicle, but rather to make the installation of vehicle accessories by the end user simpler and quicker. While this invention does in fact eliminate one wire from the accessory to the interior of the vehicle, the utility is not in the reduction of wires but rather in the simplification of the installation process. This invention also is not utilizing Digital Enhanced Cordless Telecommunications protocol, but rather a variety of other wireless communication systems in the alternative, including but not limited to Bluetooth or radio signals. This invention also provides a rigid and ergonomic mounting system for the controller unit in a power outlet in the interior of a vehicle that does not require a separate battery.

U.S. Pat. No. 5,113,427 details a vehicle device control system using radio signals. The prior art is directed to the use of a handheld radio control unit to control a vehicle function remotely.

This invention is not directed at the control of vehicle functions remotely, but rather from the interior of the vehicle. This invention also provides a rigid and ergonomic mounting system in a power outlet in the interior of a vehicle for the controller unit that does not require a separate battery.

U.S. Pat. No. 4,672,375 details a vehicle keyless entry system using a portable transmitter communicating with a controller mounted in the vehicle.

The same features of this invention that distinguish it from '427 apply to '375.

U.S. Pat. No. 6,078,252 details a vehicle wireless switching system to reduce the assembly time, cost and weight of vehicles and reduce potential failure points in vehicle wiring.

This invention is also directed to the reduction of assembly time with its utility based in making the installation of vehicle accessories by the end user simpler and quicker. This invention is different from the prior art because instead of using a battery powered or hard wired controller unit, this invention uses a power outlet in the interior of a vehicle, reducing the installation complexity for an end user of a vehicle. This invention also provides a rigid and ergonomic mounting system in a power outlet in the interior of a vehicle.

### BRIEF SUMMARY OF THE INVENTION

A vehicle includes a controller and one or more switches in communication with the controller powered by a power outlet in the interior of a vehicle, and a plurality of accessories in communication with the controller. The various accessories are each individually controlled by inputting commands into the input switch assigned to the specific accessory. The controller transmits the inputted command via a wireless communication system to the selected accessory to motivate the accessory between a first setting and a second setting. This system simplifies the installation of aftermarket accessories in vehicles, such as but not limited to fog lights.

### BRIEF DESCRIPTION OF THE SEVERAL VIEWS OF THE DRAWING

FIG. 1 is a schematic view of the interface apparatus;

FIG. 2 is a perspective view of a single input switch and controller;

FIG. 3 is an alternative configuration of multiple input switches and a controller, including a 12 volt power outlet;

FIG. 4 is an alternative configuration of a switch and controller, including a swiveling panel;

FIG. 5 is an alternative configuration of multiple switches and a controller mounted remotely from the 12 volt power outlet;

### DETAILED DESCRIPTION OF THE INVENTION

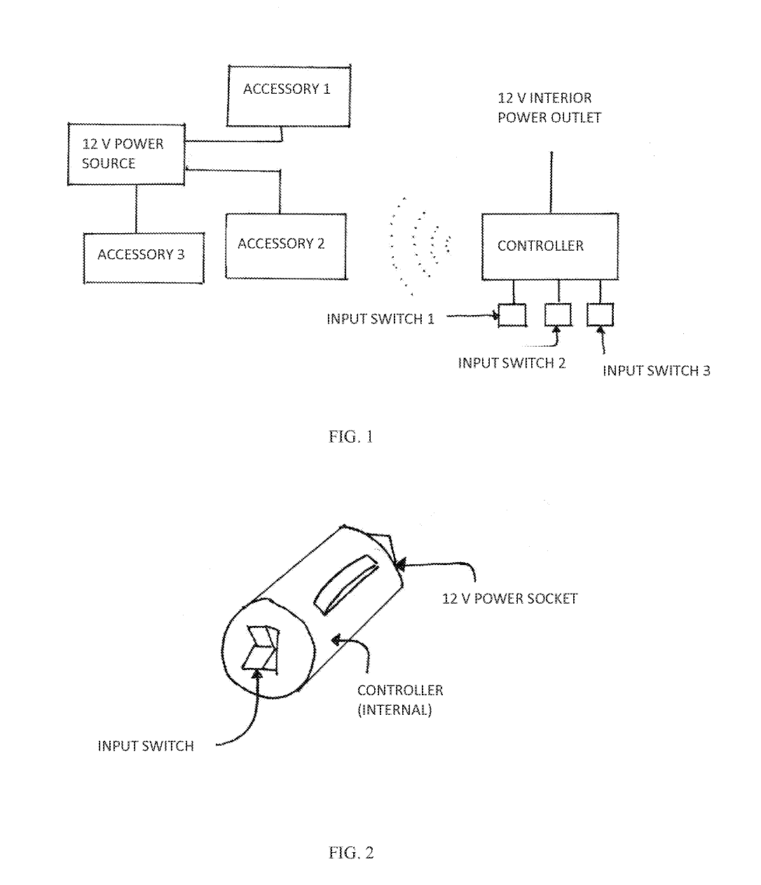

Referring to FIG. 1, the interface apparatus claimed, comprising of a controller unit mounted on the interior of a vehicle and receiving power from a twelve volt power source, commonly found inside a vehicle, communicating wirelessly with an accessory hard wired into the vehicle's electrical system.

One or more input switches are hard wired to a controller. The input switch or switches are hard wired to the controller in a single unit called the control unit. The control unit receives electrical power through the twelve volt power source commonly installed in the interior of a vehicle. One or more input switches are in communication with the controller for inputting commands into the controller. The controller is in wireless communication with one or more installed accessories. Each input switch is assigned to a corresponding accessory with at least a first setting and a second setting.

The vehicle includes at least one accessory operable in at least a first setting and a second setting. The wireless communication system interconnects the controller and the at least one accessory. The communication system transmits a command inputted into the input switch to the at least one accessory to move the at least one accessory between the first setting and the second setting. The wireless communication system may include a Bluetooth system, a Zigbee system, a RF system, or some other similar wireless communication system.

The method claimed for installing and operating a vehicle accessory using the aforementioned interface apparatus comprises the following steps: First, the installer must hard wire a vehicle accessory into the vehicle's electrical system. For example, a fog light accessory would be mounted on the front of the vehicle and wired to the vehicle's battery. The next step is to plug the controller unit into a power source located on the interior of the vehicle (also commonly called the cigarette lighter or 12 volt accessory outlet). This concludes the installation steps for the new accessory.

To operate the accessory, the ignition in most vehicles must be in the “on” or “run” position for the power source to receive power (on older vehicles, the power source receives power even when the ignition is off). The operator then manipulates the input switch on the controller unit to input a command for the accessory to move between the first setting and the second setting. The command is transmitted through the hard wired connection to the controller.

From the controller, the command is transmitted wirelessly to the accessory. The accessory then executes the inputted command by moving between the first setting and the second setting. It is also possible for the accessory to transmit a signal back to the controller unit to indicate a malfunction, failure or other relevant message.

For example, assuming the accessory is defined as a fog light for a vehicle, the first setting includes an off position and the second setting includes an energized position, and the inputted command is to energize the fog light, the accessory would move to the second setting to energize.

Referring to FIG. 2, the controller and single input switch are integrated with a power source plug. This embodiment allows for the quick and simple installation of the input switch and controller in the interior of the vehicle.

Referring to FIG. 3, multiple input switches are connected to a controller and integrated with a power source plug. This embodiment allows for the control of multiple accessories installed in the vehicle using a single interior power source. The controller unit also has a power outlet built into the unit to allow an additional 12 volt vehicle accessory to be plugged into the claimed invention.

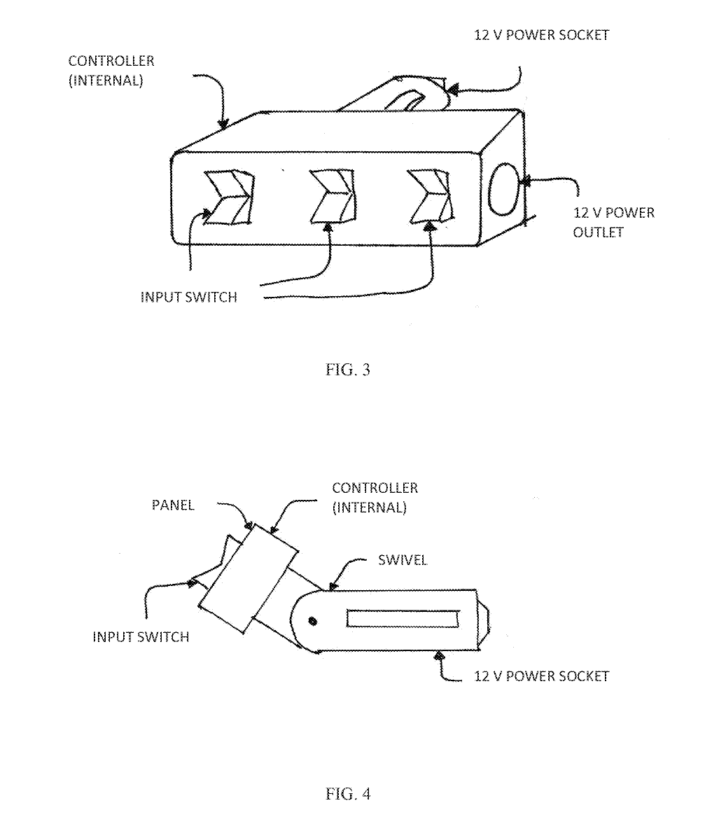

Referring to FIG. 4, the input switch is mounted on a panel, connected to the controller and integrated power source plug using a swiveling mount. This embodiment allows the vehicle operator to adjust the angle and direction the input switch faces. The swiveling mount includes a swivel pin, a ball joint, or another similar swiveling connection.

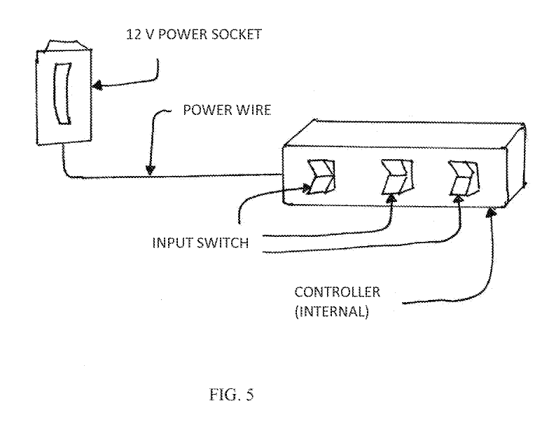

Referring to FIG. 5, multiple input switches are mounted on a panel remotely mounted from the power source plug. This embodiment allows a wireless switch panel to be mounted on the interior of a vehicle when the location of the power source in the interior of the vehicle is not located in a position that is preferable to the installer. The panel can be mounted to the interior of the vehicle using Velcro, double sided tape, or another similar fastening method. The power source plug and panel are connected using a power wire to transmit electrical power to the panel. FIG. 5 shows a power source outlet located on the side of the panel. The power source can also be located at the end of the power source plug in the alternative.

The interface apparatus claimed is different from the prior art because the controller unit is designed to be mounted on the interior of the vehicle and receive power through a power source outlet located on the interior of the vehicle. No prior art uses the twelve volt accessory outlet located inside almost every vehicle to power the controller unit. This invention therefore eliminates the need to replace batteries in existing wireless control systems that can be adapted to operate vehicle accessories.

The ability to mount the controller unit in the power source is also a difference between this invention and the prior art. Vehicle power sources are usually located in positions inside of the vehicle that are easy for the driver to reach. This is therefore an ideal location to locate an accessory input switch or switches. Mounting the controller unit in the power source also has the benefit of a quicker installation than attempting to hard wire a controller unit into the interior of the vehicle. The controller unit can also be easily removed from the vehicle if the accessory is removed.

The method of installation and operation of the interface apparatus greatly simplifies the installation process of installing a vehicle accessory, especially for the end user of the vehicle. Hard wiring only an accessory into a vehicle's electrical system is a simple task. Most accessories are mounted in the front of the vehicle and a wire can quickly be run to the vehicle's battery with an inline fuse. The difficult part of the installation that this method eliminates is the need to wire a controller unit directly to the vehicle. The prior art would require the installer to route a wire through the firewall and dashboard to install an input switch in the interior of the vehicle. Wireless control systems in the prior art would require the installer to hard wire a controller unit into a power wire on the interior of the vehicle. This invention allows the installer to simply plug the controller unit into the vehicle's interior accessory power source, completing the installation process.

Once installed, the method of operation is also better than systems in the prior art. Prior art interfaces use a “key fob” style controller unit or transmitter to operate vehicle accessories that are hard wired into the vehicle and configured to receive wireless signals. The “key fob” style controller cannot be mounted in the vehicle's interior and is difficult to use by the driver, especially while in motion. The “key fob” controller units or transmitters also require independent battery power, limiting their reliability.

What is claimed is:

1. A method of installing and operating an accessory of a vehicle with a controller unit, comprising a controller and input switch, powered by a power source in the interior of the vehicle, in wireless communication with the accessory, said method comprising the steps of: mounting and hard wiring said accessory into said vehicle's electrical system; plugging in said controller unit into a power source in the interior of the vehicle; manipulating said input switch to input a command for the accessory; transmitting the inputted command to the accessory; and executing the inputted command.

2. A method as set forth in claim 1, wherein the controller includes a wireless communication system in communication with the accessory and said step of transmitting the inputted command is further defined as wirelessly transmitting the inputted command to the accessory.

3. A method as set forth in claim 1, wherein the vehicle includes a plurality of accessories controlled by a plurality of input switches whose function is assigned to a particular accessory.

4. An interface apparatus for use in a vehicle, said interface apparatus comprising: a controller unit, comprising a controller and an input switch in communication with said controller, the input switch further configured to input a command into said controller, the controller and input switch further powered by a power source in the interior of the vehicle; an accessory configured to have at least a first setting and a second setting; a wireless communication system configured to interconnect the controller and the accessory, the wireless communication system further configured to transmit the command to the accessory to move the accessory between said first setting and said second setting.

5. The interface apparatus of claim 4, wherein said controller and input switch are mounted in the power source outlet on the interior of the vehicle.

6. The interface apparatus of claim 4, wherein said controller and input switch are mounted on a panel, the panel further mounted on the interior of the vehicle, the panel further connected to a vehicle power source with a power wire.

7. The interface apparatus of claim 5, wherein said input switch is mounted on a panel that swivels independently of the body of the controller unit.

8. The interface of apparatus of claim 4, wherein a power source is mounted to said controller unit.

9. The interface of apparatus of claim 5, wherein a power source is mounted to said controller unit.

10. The interface of apparatus of claim 7, wherein a power source is mounted to said controller unit.

11. The interface apparatus of claim 6, wherein a power source is mounted to said panel.

12. The interface apparatus of claim 4, wherein a plurality of said input switches are connected to said controller and assigned to a predetermined accessory and are connected through said wireless communication system to a plurality of accessories.

13. The interface apparatus of claim 5, wherein a plurality of said input switches are connected to said controller and assigned to a predetermined accessory and are connected through said wireless communication system to a plurality of accessories.

14. The interface apparatus of claim 6, wherein a plurality of said input switches are connected to said controller and assigned to a predetermined accessory and are connected through said wireless communication system to a plurality of accessories.

15. The interface apparatus of claim 7, wherein a plurality of said input switches are connected to said controller and assigned to a predetermined accessory and are connected through said wireless communication system to a plurality of accessories.

16. The interface apparatus of claim 8, wherein a plurality of said input switches are connected to said controller and assigned to a predetermined accessory and are connected through said wireless communication system to a plurality of accessories.

17. The interface apparatus of claim 9, wherein a plurality of said input switches are connected to said controller and assigned to a predetermined accessory and are connected through said wireless communication system to a plurality of accessories.

18. The interface apparatus of claim 10, wherein a plurality of said input switches are connected to said controller and assigned to a predetermined accessory and are connected through said wireless communication system to a plurality of accessories.

19. The interface apparatus of claim 11, wherein a plurality of said input switches are connected to said controller and assigned to a predetermined accessory and are connected through said wireless communication system to a plurality of accessories.
